(19) United States
(12) Patent Application Publication
(10) Pub. No.: US 2025/0229514 A1
(43) Pub. Date: Jul. 17, 2025

(54) METHOD OF MANUFACTURING A BUILDING ELEMENT AND A BUILDING ELEMENT

(71) Applicant: Välinge Innovation AB, Viken (SE)

(72) Inventors: Anette HEDLUND, Klippan (SE); Sofia NILSSON, Strandbaden (SE)

(73) Assignee: Välinge Innovation AB, Viken (SE)

(21) Appl. No.: 19/075,008

(22) Filed: Mar. 10, 2025

Related U.S. Application Data
(63) Continuation of application No. 16/738,468, filed on Jan. 9, 2020, now Pat. No. 12,275,218.

(30) Foreign Application Priority Data
Jan. 10, 2019 (SE) 1950022-2

(51) Int. Cl. B32B 27/20; B05D 1/30; B32B 27/42; B32B 37/06; B32B 37/10; E04F 15/10

(52) U.S. Cl. CPC B32B 27/20; B05D 1/30; B32B 27/42; B32B 37/06; B32B 37/10; E04F 15/105; B05D 2203/20; B05D 2401/32; B05D 2601/20; B32B 2264/067; B32B 2264/102; B32B 2264/104; B32B 2305/30; B32B 2471/00

(57) ABSTRACT

A method of manufacturing a building element, including applying a first layer on a first surface of a substrate, the first layer including a mixture of a binder, at least one filler and fine non-pigment cohesive particles, wherein an amount of the fine non-pigment cohesive particles in the mixture may be between 0.05 wt % and 9 wt % of the mixture, and applying heat and/or pressure to the first layer and/or the substrate thereby forming the building element. The disclosure further relates to such a building element.

### CROSS REFERENCE TO RELATED APPLICATIONS

The present application is a continuation of U.S. application Ser. No. 16/738,468, filed on Jan. 9, 2020, which claims the benefit of Swedish Application No. 1950022-2, filed on Jan. 10, 2019. The entire contents of U.S. application Ser. No. 16/738,468 and Swedish Application No. 1950022-2 are hereby incorporated herein by reference in their entirety.

### Technical Field

Embodiments of the present invention relate to a method of manufacturing a building element and a building element.

### Technical Background

Floor coverings having a wooden surface may be of several different types. Solid wood flooring is formed of a solid piece of wood in form of a plank. Engineered wood flooring is formed of a surface layer of wood glued to a core. The core may be a lamella core or a wood-based panel such as plywood, MDF or HDF. The wooden surface layer may as an example have a thickness of 2-10 mm.

A wooden floor covering may also be formed by gluing a wood veneer to a substrate, for example, a wood-based panel such as particleboard, MDF or HDF. Wood veneer is a thin wood layer, for example having a thickness of 0.2-1 mm. A flooring with a separate surface layer glued to a core of for example HDF or plywood is more moisture stable than solid wood floorings.

Compared to solid wood and engineered wood floorings, wood veneer floorings can be produced to a lower cost since only a thin wood layer is used.

A new type of floors has recently been developed with a solid surface comprising a substantially homogenous mix of wood particles, a binder and wear resistant particles. Such floor and building panels are marketed under the trademark NADURA®.

The panels are produced according to a production method wherein the mix comprising wood powder, binder such as melamine formaldehyde and optionally, wear resistant particles is applied in powder form on a core. Such a method is disclosed in WO 2009/065769. A method of controlling a loss on cure in such a method is disclosed in US 2012/0263878.

The mix is scattered in dry powder form on a wood based core, such as for example HDF. It has been shown that wood powder has quite low flowability through low stress environments, such as discharge from big bags, air conveying and scattering. For example, it is difficult to scatter wood powder evenly across a substrate without obtaining naked areas with no wood powder present, areas with less powder, or areas with an increased amount of powder applied. The reason is that wood powder is bridge building and ratholing in low stress processes. By ratholing is meant emptying of material only in the centre of a hopper or silo, thus leaving circumferential material.

These two behaviors are due to the particle texture, shape and density, which for wood powder all increase the risk of mechanical interlocking, bridging or ratholing as a result. The wood powder particles or fibres are rough with kinks and fibrils, are fibrous and thereby far from spherical and the particles are not dense enough to induce bridge breaking gravitational forces.

The binder, which is the other main component of the mix, usually comprises more free flowing particles, at least compared to the wood powder

After the mix has been applied on the core, the mix is thereafter cured under heat and pressure to a 0.1-1.0 mm thick surface layer arranged on the core. When curing the melamine formaldehyde resin, shrinking of the melamine formaldehyde resin leads to tension in the layer. The internal stress formed in the layer may cause warping of the panel. The tension at the front side of the panel must be compensated by a counteractive tension at the rear side of the panel. Therefore, typically a balancing layer is arranged on a rear side of the core opposite the layer. The balancing layer is adapted to balance shrinking and expansion caused by both pressing, cooling and climate changes. The balancing layer may be a resin impregnated paper or a powder formed of a mix comprising wood powder and a thermosetting binder.

US 2005/0250879 relates to powder coating films formed by melting or flowing powder coating particles into a cohesive layer, followed by curing the components to form a continuous film. Powder compositions comprising mixtures of ingredients as unassociated discrete particles in a raw mix having an average particle size ranging from 1 to 25 μm. The raw mix comprises one film-forming (co)polymer or resin.

### SUMMARY

It is an object of at least some embodiments of the present invention to provide an improvement over the above described techniques and known art.

A further object of at least some embodiments of the present invention is to optimize a process of producing the building element.

A further object of at least some embodiments of the present invention is to make the process more cost efficient, and consequently reduce the costs of the building element while preserving good quality.

A further object of at least some embodiments of the present invention is to apply a layer having a uniform thickness.

A further object of at least some embodiments of the present invention is to improve the shape of the building element.

At least some of these and other objects and advantages that will be apparent from the description have been achieved by at least some aspects disclosed herein below.

In a first aspect it is disclosed a method of manufacturing a building element, comprising applying a first layer on a first surface of a substrate, the first layer comprising a mixture of a binder, at least one filler and cohesive particles, and applying heat and/or pressure to the first layer and/or substrate, thereby forming the building element.

The cohesive particles may be fine cohesive particles. Fine particles may be defined as at least 70% of the particles having a length in their largest dimension of 2.5 μm or less, such as a length in their largest dimension between 0.1 μm and 2.5 μm.

An amount of the cohesive particles in the mixture may be between 0.05 wt % and 9 wt %.

The cohesive particles may be non-pigment cohesive particles. By non-pigment cohesive particles may be meant particles not being conventional pigments, such as such as titanium pigments, carbon black, iron oxide pigments, copper pigments, etc. An example of a conventionally used titanium pigment is titanium dioxide. The non-pigment cohesive particles may be particles having a low capacity of changing the colour of reflecting, absorbing or transmitting light as a result of wavelength selective absorption. Consequently, cohesive particles are not conventionally used in the meaning of pigment in the industry. Conventional pigments may have a size of less than 500 nm. Reflecting pigments, such as white pigments, have a comparably larger size (such as 300-400 nm) than absorbing pigments.

The cohesive particles may be fine non-pigment cohesive particles.

It shall be understood that cohesive particles are particles having cohesive attraction or cohesive force. Cohesive force is the action or property or like of particles sticking together, being mutually attractive. It is an intrinsic property of a substance that is caused by the shape and structure of at least one particle, creating electrical attraction that can maintain a microscopic structure. In other words, cohesion allows for surface energy reduction by creating a bulk-like atmosphere for the particle surface molecules.

An advantage of the first aspect is that the fine cohesive particles tend to coat fillers such as wood powder including wood fibres or wood particles, filling the holes, pores, kinks and fibrils, due to their cohesive properties. Thereby, the cohesive particles make the wood particles smoother and less prone to mechanically interlocking. Consequently, the risk for bridging and/or ratholing as explained above is at least reduced.

When bridging and/or ratholing is reduced, the risk for uneven application of the mixture on the substrate is at least reduced. Thereby, the first layer may have a uniform thickness throughout its extension. A uniform thickness is desirable aesthetically, but also due to balancing of the first layer. If the first layer has a uniform thickness, the forces required from the balancing layer to counteract the forces formed from the first layer during and/after curing will be reduced. Thereby, the amount of binder in the balancing layer can be reduced.

The cohesive particles normally exhibit poor flowability due to their high cohesive behavior. Fillers, such as wood powder, exhibit poor flowability due to high risk for mechanical interlocking. However, it has been surprisingly been discovered, and shown herein, that the two different properties can be balanced in order to surprisingly increase flowability by a certain concentration of cohesive particles in the mixture. If the amount of cohesive particles in the mixture is too low, the mechanical interlocking properties of the wood powder will dominate, resulting in low flowability. If the amount of cohesive particles in the mixture is too high, the cohesive properties of the cohesive particles will dominate, resulting in low flowability. The amount of cohesive particles should be balanced in order to improve flowability. The amount of the fine non-pigment cohesive particles in the mixture may be between 0.05 wt % and 9 wt % of the mixture.

An advantage is that the heat and/pressure treated first layer has essentially the same thickness throughout its entire extension, preferably both in its longitudinal and its transverse extension.

An advantage of the increased flowability is that the mixture is more evenly distributed over the substrate.

A cohesion force of said cohesive particles, such as fine non-pigment cohesive particles, may be exceeding a cohesive force of said at least one filler. Thereby, the cohesive particles tend to coat the fillers.

A cohesion force of said cohesive particles, such as fine non-pigment cohesive particles, may be at least 0.25 kPa, such as 0.25 to 3 kPa, as measured with standard Shear Cell Program, 50 mm shear 6 kPa (FT4 Powder Rheometer). Standard Shear Cell Program is a standard program for a Freeman Technology FT4 Powder Rheometer. When using wood powder as a filler, the cohesion force of wood powder comprising wood fibre is measured to be 0.25 kPa when measured with said standard Shear Cell Program.

The mixture may be provided in dry form.

The mixture may be applied on the substrate in a dry form.

The mixture may be a dry powder.

An amount of cohesive particles, such as fine non-pigment cohesive particles, in the mixture may be between 0.2 wt % and 4.5 wt %.

An amount of cohesive particles, such as fine non-pigment cohesive particles, in the mixture may be between 0.5 wt % and 5 wt %, such as between 2 wt % and 4 wt %.

At least 70% of the cohesive particles, such as fine non-pigment cohesive particles, may have a length in their largest dimension of 2.5 μm or less, preferably a length in their largest dimension between 0.1 μm and 2.5 μm.

The cohesive particles, such as fine non-pigment cohesive particles, may have a length in their largest dimension of 2.5 μm or less, preferably a length in their largest dimension between 0.1 μm and 2.5 μm.

The cohesive particles, such as fine non-pigment cohesive particles, may have a refractive index (RI) of less than 1.9.

The cohesive particles, such as fine non-pigment cohesive particles, may be selected from silicates, such as aluminium silicate or silicon oxides, such as SiO₂.

SiO₂ may be provided as fumed silica.

The cohesive particles, such as fine non-pigment cohesive particles, may be calcium carbonate.

The cohesive particles, such as fine non-pigment cohesive particles, may be barium sulphate.

The cohesive particles, such as fine non-pigment cohesive particles, may be polytetrafluorethylene.

Said at least one filler may be or comprise fibres.

Said at least one filler may comprise wood powder. The wood powder may comprise wood fibres or wood particles. The wood fibre particle size may be 0-300 μm, such as 0-150 μm. The wood fibre particle size may be 10-300 μm, such as 10-150 μm.

The binder may be a thermosetting binder or a thermoplastic binder.

The binder may be urea formaldehyde resin, a mixture comprising urea formaldehyde resin, or a co-polymer comprising urea formaldehyde resin, phenol formaldehyde resin, a mixture comprising phenol formaldehyde resin, or a co-polymer comprising phenol formaldehyde resin, melamine formaldehyde resin, a mixture comprising melamine formaldehyde resin, or a co-polymer comprising melamine formaldehyde resin or mixture thereof.

The first layer may further comprise wear resistant particles.

The first layer may further comprise pigment particles.

The substrate may be selected from a wood-based board, a particleboard, a thermoplastic board, a plywood, a lamella core, a veneer layer.

The first layer may be permanently attached to the substrate, thereby forming a building panel.

The building panel may be a floor panel or wall panel.

The method may further comprise applying a surface layer, as a second layer, on top of the first layer.

The method may further comprise applying a balancing layer on a second surface of a substrate, the second surface being opposite to the first surface of the substrate.

In a second aspect, a building element is provided. The building element comprises a first layer arranged on a substrate, the first layer formed by a mixture comprising a binder, at least one filler and cohesive particles, wherein said building element is formed by applying heat and/or pressure.

The building element may be cured by applying heat and/or pressure.

The cohesive particles may be fine cohesive particles. Fine particles may be defined as at least 70% of the particles having a length in their largest dimension of 2.5 μm or less, such a length in their largest dimension between 0.1 μm and 2.5 μm.

An amount of the cohesive particles in the mixture may be between 0.05 wt % and 9 wt %.

The cohesive particles may be non-pigment cohesive particles. By non-pigment cohesive particles may be meant particles not being conventional pigments, such as such as titanium pigments, carbon black, iron oxide pigments, copper pigments, etc. An example of a conventionally used titanium pigment is titanium dioxide. The non-pigment cohesive particles may be particles having a low capacity of changing the colour of reflecting, absorbing or transmitting light as a result of wavelength selective absorption. Consequently, cohesive particles are not conventionally used in the meaning of pigment in the industry. Conventional pigments may have a size of less than 500 nm. Reflecting pigments, such as white pigments, have a comparably larger size (such as 300-400 nm) than absorbing pigments.

The cohesive particles may be fine non-pigment cohesive particles.

It shall be understood that cohesive particles are particles having cohesive attraction or cohesive force. Cohesive force is the action or property or like of particles sticking together, being mutually attractive. It is an intrinsic property of a substance that is caused by the shape and structure of at least one particle, creating electrical attraction that can maintain a microscopic structure. In other words, cohesion allows for surface energy reduction by creating a bulk-like atmosphere for the particle surface molecules.

The second aspect incorporates all the advantages of the first aspect, which previously has been discussed, whereby the previous discussion is applicable also to the building element.

A cohesion force of said cohesive particles, such as fine non-pigment cohesive particles, may be exceeding a cohesive force of said at least filler.

A cohesion force of said cohesive particles, such as fine non-pigment cohesive particles, may be at least 0.25 kPa, such as 0.25to 3 kPa, as measured with standard Shear Cell Program, 50 mm shear 6 kPa (FT4 Powder Rheometer. Standard Shear Cell Program is a standard program for a Freeman Technology FT4 Powder Rheometer.

The mixture may be provided in dry form.

The mixture may be applied on the substrate in a dry form.

The mixture may be a dry powder.

An amount of cohesive particles, such as fine non-pigment cohesive particles, in the mixture may be between 0.2 wt % and 4.5 wt %.

An amount of cohesive particles, such as fine non-pigment cohesive particles, in the mixture may be between 0.5 wt % and 5 wt %, such as between 2 wt % and 4 wt %.

At least 70% of the cohesive particles, such as fine non-pigment cohesive particles, may have a length in their largest dimension of 2.5 μm or less, preferably a length in their largest dimension between 0.1 μm and 2.5 μm.

The cohesive particles, such as fine non-pigment cohesive particles, may have a length in their largest dimension of 2.5 μm or less, preferably a length in their largest dimension between 0.1 μm and 2.5 μm.

The cohesive particles, such as fine non-pigment cohesive particles, may have a refractive index (RI) of less than 1.9.

The cohesive particles, such as fine non-pigment cohesive particles, may be selected from silicates, such as aluminium silicate or silicon oxides, such as SiO₂.

SiO₂ may be provided as fumed silica.

The cohesive particles, such as fine non-pigment cohesive particles, may be calcium carbonate.

The cohesive particles, such as fine non-pigment cohesive particles, may be barium sulphate.

The cohesive particles, such as fine non-pigment cohesive particles, may be polytetrafluorethylene.

Said at least one filler may comprise wood powder. The wood powder may comprise wood fibres or wood particles.

The binder may be a thermosetting binder or a thermoplastic binder.

The binder may be urea formaldehyde resin, a mixture comprising urea formaldehyde resin, or a co-polymer comprising urea formaldehyde resin, phenol formaldehyde resin, a mixture comprising phenol formaldehyde resin, or a co-polymer comprising phenol formaldehyde resin, melamine formaldehyde resin, a mixture comprising melamine formaldehyde resin, or a co-polymer comprising melamine formaldehyde resin or mixture thereof.

The first layer may further comprise wear resistant particles.

The first layer may further comprise pigment particles.

The substrate may be selected from a wood-based board, a particleboard, a thermoplastic board, a plywood, a lamella core, a veneer layer.

The first layer may be permanently attached to the substrate, thereby forming a building panel.

The building panel may be a floor panel or wall panel.

The building panel may further comprise a surface layer, as a second layer, on top of the first layer.

The building panel may further comprise a balancing layer arranged on a second surface of a substrate, the second surface being opposite to the first surface of the substrate.

### BRIEF DESCRIPTION OF THE DRAWINGS

Embodiments of the present invention will by way of example be described in more detail with reference to the appended schematic drawings, which show embodiments of the present invention.

FIG. 1A shows a method of producing a building element.

FIG. 1B shows an embodiment of a building element.

FIG. 1C shows an embodiment of a building element.

FIG. 1D shows an embodiment of a building element.

FIG. 2A shows a reference powder composition.

FIG. 2B shows an exemplary powder composition in accordance with an embodiment of the invention.

FIG. 3A shows a result of a free fall experiment of sample A and sample F in Example 1.

FIG. 3B shows a result of a scattering experiment of sample A and sample F in Example 2.

FIG. 4A shows permeability results of selected fine non-pigment cohesive particles compared to a reference sample.

FIG. 4B shows permeability results dependent on concentration of calcium carbonate represented by MIKHART C®.

FIG. 4C shows permeability results dependent on concentration of fine high brightness aluminium silicate represented by POLYGLOSS 90®.

### DETAILED DESCRIPTION

It is disclosed herein a method of manufacturing a building element 10, comprising applying a first layer 1 on a first surface of a substrate 2, the first layer 1 comprising a mixture of a binder, at least one filler and cohesive particles 4, applying heat and/or pressure to the first layer and/or the substrate thereby forming the building element 10.

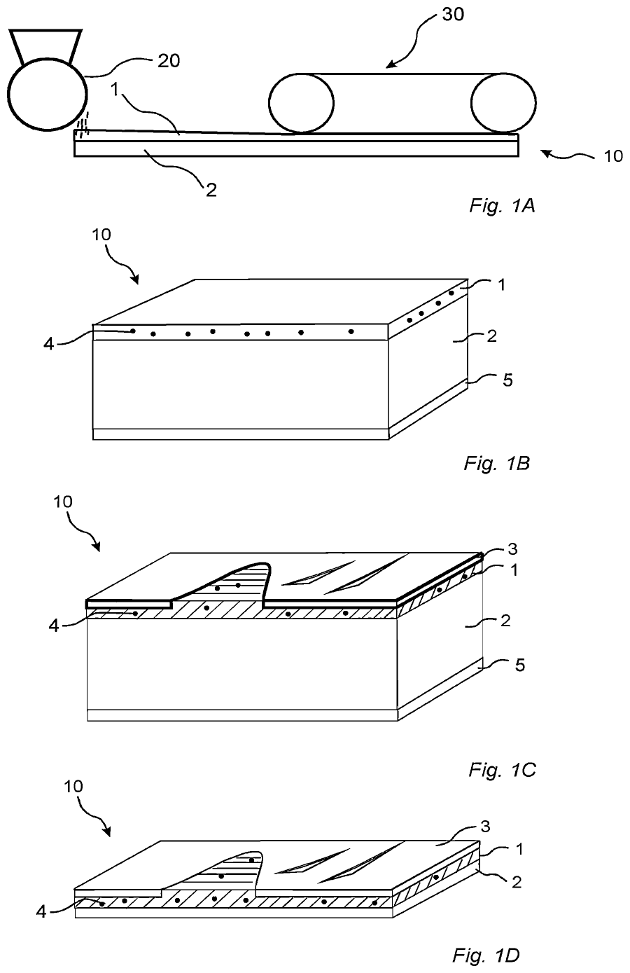

The method of manufacturing the building element 10, and the building element 10 thereby formed, will now be described with reference to FIGS. 1A-D.

The building element 10 may be a building panel, such as floor panel, a ceiling panel, a wall panel, a door panel, a worktop, a furniture component or part of a furniture component, skirting boards, mouldings, edging profiles etc.

The method comprises providing a substrate 2. The substrate is preferably a pre-fabricated substrate, produced prior to the method of manufacturing a building element 10. A substrate may comprise at least one wood veneer layer. The substrate may comprise several wood veneer layers, such as being plywood. Preferably, the veneered element includes an uneven number of wood veneer layers. The substrate may comprise a wood-based panel. The wood-based panel may be selected from the group comprising of HDF, MDF, OSB, lamella core, and solid wood. The substrate may be a thermoplastic board. The substrate may comprise a thermoplastic material. The substrate may be a mineral composite board. The substrate may be a fibre cement board. The substrate may comprise a sheet such as a paper sheet or sheet of non-woven material or a conveyor. The substrate is preferably a pre-fabricated substrate, produced prior to the method of manufacturing a building element 10. The wood-based substrate may be a wood fibre-based board such as MDF, HDF, particleboard or plywood board. The substrate may be a Wood Plastic Composite (WPC). The substrate may be a mineral composite board. The substrate may be magnesium oxide cement board. The substrate may be a ceramic board. The substrate may be a plastic board such as a thermoplastic board.

The substrate 2 may be a carrier, such as a sheet of paper, a non-woven sheet, or a wood veneer.

When the first layer 1 is permanently attached to the substrate 2 the building element 10 is a building panel. Permanently means that the substrate cannot be detached from the at least a first layer after they are attached to the substrate by applying heat and/or pressure.

When substrate is a temporary carrier, such as a sheet of paper or non-woven sheet or a conveyor, the first layer is reversibly attached to the substrate 10. Reversibly means that the at least a first layer 1 may be detached from the substrate 2 after application of heat and/or pressure.

The substrate 2 has two surfaces. The first surface is facing the first layer 1. The second surface is the surface of the substrate 2 opposite of the first surface. If, optionally, a balancing layer 5 is applied to the substrate, the second surface of the substrate 2 is facing the balancing layer 5.

According to another aspect, the method further comprises applying a balancing layer 5 on a second surface of a substrate 2, the second surface being opposite to the first surface of the substrate 2.

The balancing layer 5 may be a powder based balancing layer being applied as a powder. The powder based balancing layer may comprise wood particles such as lignocellulosic and/or cellulosic particles and a binder, preferably a thermosetting binder such as an amino resin. The balancing layer may be a resin impregnated paper, preferably impregnated with a thermosetting binder. The balancing layer may have the same composition as the first layer 1.

A first layer 1 is applied on a first surface of the substrate 2. The first layer 1 may be applied by scattering, as shown in FIG. 1A.

The first layer 1 is formed by a mixture comprising a binder, at least one filler, and cohesive particles.

The mixture is applied in dry form. The mixture is preferably applied in dry powder form.

Said least one filler may be particles or fibres, for example, wood fibres or particles, or mineral particles or fibres. The wood particles may be lignocellulosic particles and/or cellulosic particles. The wood particles may be at least partially bleached or have the original wood colour. Particles may be also colored prior to adding them to a mixture. A filler may be rice, straw, corn, jute, linen, flax, cotton, hemp, bamboo particles or fibres. A filler may be metals, ceramic filler, a composite filler, etc.; for example, silicates or silicone oxides.

In the following, particles and fibres will be used as substitutes.

It may be the case that more than one filler is present in a mixture. The mixture may comprise a combination of two or more fillers discussed above.

A binder may be a thermosetting or thermoplastic binder.

The first layer 1 may comprise a thermosetting binder. The thermosetting binder may be an amino resin such as melamine formaldehyde, urea formaldehyde, or a combination thereof. The thermosetting binder may be phenol formaldehyde.

The first layer 1 may comprise a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof. The thermoplastic binder simultaneously bonds the first surface of the substrate 2 to the first layer 1.

According to another aspect, the first layer 1 may comprise, as a thermosetting binder, a urea formaldehyde resin, urea formaldehyde resin, or a co-polymer comprising urea formaldehyde resin, phenol formaldehyde resin, phenol formaldehyde resin, or a co-polymer comprising phenol formaldehyde resin, melamine formaldehyde resin, melamine formaldehyde resin, or a co-polymer comprising melamine formaldehyde resin or mixtures thereof.

The mixture may further comprise cohesive particles, such as fine non-pigment cohesive particles.

A particle is a powder component with a discrete quantity of matter and with the surface to the immediate surrounding, meaning either a single discrete component or two or more such components bound together chemically or physically by a coupling agent to form one solid unit of greater mass and/or size.

The cohesive particles may be fine cohesive particles.

The cohesive particles may be non-pigment particles, such as fine non-pigment cohesive particles.

The cohesive particles, such as fine non-pigment cohesive particles, may be selected from silicates, silicon oxides, calcium carbonate, barium sulphate, polytetrafluorethylene.

The cohesive particles, such as fine non-pigment cohesive particles, may be selected from silicates, such as aluminium silicate, magnesium silicate or silicon oxides, preferably SiO₂, preferably as fumed silica.

The cohesive particles, such as fine non-pigment cohesive particles, may be selected from calcium carbonate (CaCO₃, such as MIKHART C®), barium sulphate such as BaSO₄ BB30EX, aluminium silicate such as POLYGLOSS 90®, hydrated magnesium silicate, calcinated aluminum silicate (fired raw kaolin with reduced crystalline water content), polytetrafluorethylene such as ALGOFLON® and fumed silica such as HDK N20®.

It shall be understood that cohesive particles are particles having cohesive attraction or cohesive force. Cohesive force is the action or property or like of particles sticking together, being mutually attractive. It is an intrinsic property of a substance that is caused by the shape and structure of at least one particle, creating electrical attraction that can maintain a microscopic structure. In other words, cohesion allows for surface energy reduction by creating a bulk-like atmosphere for the particle surface molecules.

By fine particle it is typically understood that at least 70% of the particles have a length in their largest dimension of 2.5 μm or less, preferably that the particles have a length in their largest dimension of 2.5 μm or less.

Fine cohesive particles, such as fine non-pigment cohesive particles, are thus particles wherein at least 70% of the particles having a size, preferably the length in their largest dimension, being between 0.1 μm and 2.5 μm, such that particles having a size, preferably the length in their largest dimension, being between 0.1 μm and 2.5 μm.

A cohesion force of the cohesive particles may exceed a cohesive force of said at least one filler, such that the cohesive particles coat the fillers. The cohesion force of the cohesive particles may be at least 0.25 kPa, such 0.25-3 kPa, as measured with standard Shear Cell Program, 50 mm shear 6 kPa (FT4 Powder Rheometer).

According to an aspect, the cohesive particles, such as fine non-pigment cohesive particles, in the first layer are present in an amount of 0.05 wt % to 9 wt % in the mixture.

Preferably, the amount of cohesive particles, such as fine non-pigment cohesive particles, in the mixture is between 0.3 wt % and 8.5 wt %, preferably between 1 wt % and 7 wt %, preferably between 2 wt % and 6 wt %, preferably between 4 wt % and 5 wt %. In one embodiment, the amount of non-pigment cohesive particles in the mixture may be about 7.5 wt %.

In one embodiment, the amount of non-pigment cohesive particles in the mixture may be about 2.5 wt %.

In an aspect, the amount of cohesive particles, such as fine non-pigment cohesive particles, in the mixture may be between 0.2 wt % and 4.5 wt %, preferably between 0.2 wt % and 2.5 wt %.

In an aspect, the amount of cohesive particles, such as fine non-pigment cohesive particles, in the mixture may be between 0.3 wt % and 5 wt %, preferably between 0.5 wt % and 5 wt %, more preferably between 2 wt % and 4 wt %.

In one embodiment, the amount of non-pigment cohesive particles in the mixture may be about 0.1 wt %.

According to another aspect, the fine non-pigment cohesive particles are selected from silicates, such as aluminium silicate or silicon oxides, preferably SiO₂, preferably as fumed silica.

In particular, if aluminium silicate is used as fine non-pigment cohesive particles, the amount of aluminium silicate in the mixture may be between 0.5 wt % and 9 wt %, such as between 0.5 wt % and 5 wt %, preferably between 2 wt % and 4 wt %. In an aspect, the amount of aluminium silicate in the mixture may be between 0.3 wt % and 5 wt %.

If fumed silica, such as SiO₂, is used as fine non-pigment cohesive particles, the amount of silicon oxides in the mixture may be between 0.05 wt % and 3 wt %, preferably between 0.05 wt % and 0.7 wt %, such as between 0.1 wt % and 0.7 wt %, preferably between 0.3 wt % and 0.7 wt %.

Preferably, fine non-pigment cohesive particles may be selected from calcium carbonate (CaCO₃, such as MIKHART C®), BaSO₄ BB30EX, POLYGLOSS 90® (aluminum silicate), hydrated magnesium silicate, calcinated aluminum silicate (fired raw kaolin with reduced crystalline water content), ALGOFLON® (polytetrafluorethylene) and HDK N20® (fumed silica).

If calcium carbonate is used as fine non-pigment cohesive particles, the amount of calcium carbonate in the mixture may be between 0.3 wt % and 9 wt %, preferably between 0.3 wt % and 5 wt % such as between 0.5 wt % and 5 wt %, preferably between 2 wt % and 4 wt %. In an aspect, the amount of calcium carbonate in the mixture may be between 0.5 wt % and 9 wt %.

If barium sulphate is used as fine non-pigment cohesive particles, the amount of calcium carbonate in the mixture may be between 0.3 wt % and 9 wt %, preferably between 0.3 wt % and 5 wt % such as between 0.5 wt % and 5 wt %, preferably between 2 wt % and 4 wt %. In an aspect, the amount of barium sulphate in the mixture may be between 0.5 wt % and 9 wt %.

If polytetrafluorethylene is used as fine non-pigment cohesive particles, the amount of calcium carbonate in the mixture may be between 0.3 wt % and 9 wt %, preferably between 0.3 wt % and 5 wt % such as between 0.5 wt % and 5 wt %, preferably between 2 wt % and 4 wt %. In an aspect, the amount of polytetrafluorethylene in the mixture may be between 0.5 wt % and 9 wt %.

According to another aspect, SiO₂ is a fumed silica.

In one aspect, the first layer may further comprise pigment.

In another aspect, the first layer may comprise essentially no pigment.

Preferably, cohesive particles, such as fine non-pigment cohesive particles, have a refractive index (RI) of less than 1.9, such as 1.0-1.9. When refractive index is equal to or below 1.9, the fine non-pigment cohesive particles discolor the first layer less that the particles having refractive index more than 1.9. Thereby, fine non-pigment cohesive particles in accordance with certain embodiments of the invention do not significantly affect certain properties of the first layer, such as colour.

Preferably, cohesive particles such as fine non-pigment cohesive particles have a refractive index of about 1.56, such as the cohesive particles being aluminium silicate.

Preferably, cohesive particles such as fine non-pigment cohesive particles have a refractive index of about 1.46, such as the cohesive particles being fumed silica (such as AEROSIL®).

The refractive index of cohesive pigment particles is a number that describes how fast light propagates through the material and is defines as:

Refractive Index (RI)=speed of light/phase velocity of the light in the medium. Refractive index can be measured with refractometers, such as OPTi Digital Range refractometers from Bellingham and Stanley.

The dry mixture preferably comprises between 30 wt % to 47 wt % of filler such as wood powder, preferably 33-45 wt %, more preferably 35 wt % or 44 wt %.

The dry mixture preferably comprises between 44 wt % and 70 wt % of at least one binder (or a mixture of binders), such as 49-54 wt %, or 60-75 wt %.

The dry mixture preferably comprises between 0.05 wt % and 9 wt % of cohesive particles, such as fine non-pigment cohesive particles. For example, when aluminium silicate is used, the mixture preferably comprises aluminium silicate in the amount between 2-4 wt %. For example, when fumed silica is used, it is preferably comprised in the dry mixture in the amount 0.2-0.7 wt %.

The mixture may be applied in an amount of 200-600 g/m², preferably 300-500 g/m², such as about 400 g/m² thereby forming a first layer. The amount of binder in the applied mixture may be 100-300 g/m², preferably 150-250 g/m² such as about 200 g/m².

The mixture of a binder, at least one filler and fine non-pigment cohesive particles may be distributed on the first surface of the substrate 2 to form a first layer 1, as shown in FIG. 1A, or may be mixed with further additives, and/or wear resistant particles and/or pigments or dyes to be distributed over the first surface of the substrate 2.

It has been surprisingly discovered by the inventors that fine non-pigment cohesive particles added in the above disclosed ranges to the dry mixture comprising a binder and at least one filler increase free flow of the dry mixture of the first layer.

At the same time addition of such particles to the well-balanced composition had no material negative effect on other properties of the mixture. The process parameters for the production of the building element such as pressure, temperature and time remained largely unchanged.

It has been discovered by the inventors that fine non-pigment cohesive particles are suitable for the purpose and does not materially affect any other parameters of the mixture and the first surface layer in a negative way. Thus, a mixture comprising a binder, at least one filler and fine non-pigment cohesive particles may form a first layer of the building element as defined herein.

Including non-pigment cohesive particles in the mixture improves free flow of the first layer, thereby allowing for a better distribution of the layer. It also improves the attachment of the first layer 1 to the substrate 2 after pressing.

The first layer 1 may also have other properties such as wear-resistant properties, provided by additives such as wear resistant particles. Wear resistant particles may be aluminium oxide particles, such as corundum.

The first layer 1 may comprise further additives such as wetting agents, anti-static agents and/or heat conductive additives such as aluminium, catalysts.

Flowability of the dry mixture positively created by the addition of fine non-pigment cohesive particles that improves curing of a building element when applying heat and/or pressure, since the board coming out of press has an improved shape.

The balancing of the product is thereby improved. A balancing layer 5, if any may be thinner than is conventionally used in the art.

There may be an additional or intermediate layer arranged on the first layer 1 or on the first surface of the substrate 2, not shown on FIGS. 1A-D. The intermediate layer may be, but not limited to, a cork layer or cork veneer layer, having sound-absorbing properties.

Moisture may be applied to the first layer 1 prior to pressing. The first layer 1 may be dried and or stabilized by applying heat, for example by IR or NIR.

The mixture is applied on the substrate 2 to form the first layer 1 and pressed together by applying heat and/or pressure to the first layer 1 and/or substrate 2, as shown in FIG. 1A. If the first layer 1 includes a thermosetting binder, the first layer 1 is cured by applying heat and/or pressure. Preferably pressure may be applied. Pressure applied may be between 20 to 60 Bar. The pressure may be applied by continuous press or discontinuous press to the first layer. The pressure is preferably between 40 and 60 bars, when the press is discontinuous, or between 20 bar to 60 bar when the press is continuous. A temperature is preferably between 150° C. and 250° C.

A surface layer 3 may optionally be applied on the first layer 1, preferably prior to pressing. The first layer 1 may be pre-pressed prior to applying the surface layer 3 or may be scattered onto the substrate 2, preferably prior to pressing.

A surface layer 3 may applied on the first layer 1, thereby forming a second layer above the first layer 1. The surface layer 3 may be a veneer layer as shown in FIG. 1C. The surface layer may be or comprise a wood veneer or cork veneer. The density of the wood veneer may be at least 1000 kg/m³, for example, from 1000 to 5,000 kg/m³. The wood veneer layer may be formed of compressed wood veneer. By the wood veneer having a density of at least 1000 kg/m³, or being compressed to a density 1000 kg/m³, the hardness of the wood veneer is increased. Wood veneer is a thin wood layer, for example having a thickness of 0.2-1 mm. The surface layer 3 may be continuous or discontinuous. The surface layer 3 may be formed of several veneer pieces. The surface layer may be overlapping or non-overlapping. A gap may be formed between the veneer pieces.

When a surface layer 3 is applied on the first layer 1, the binder, such as a thermosetting binder of the above described type, simultaneously bonds the surface layer 3 with the first layer 1 during pressing. When heat and/or pressure are applied to the first layer 1, the thermosetting binder becomes fluid before cross-linking takes place. The applied heat and pressure results in curing of the thermosetting binder of the first layer 1, simultaneously as bonding the surface layer 3 to the first layer 1.

In an embodiment, a produced building element may be 6-25 mm thick, preferably 8-15 mm thick after pressing, while the substrate may be 5-22 mm thick, preferably 7-14 mm thick. The first layer may be 0.1-2 mm thick after pressing.

Exemplary building elements 10 produced by embodiments of the above described method are shown in FIGS. 1B-D.

In the embodiment shown in FIG. 1B, the building element 10 is a building panel. The building element comprises the first layer 1 as described above, the substrate 2 of the above described type and the balancing layer 5.

In the embodiment shown in FIG. 1C, the building element is a building panel. The building element comprises the first layer 1 as described above, the substrate 2 of the above described type and the balancing layer 5. In the embodiment shown in FIG. 1C, the building element 10 further comprises a surface layer 3, comprising a wood veneer.

In the embodiment shown in FIG. 1D, the building element 10 comprises the first layer 1 as described above, a surface layer 3 comprises a first wood veneer arranged on the first layer 1, and a substrate 2 comprising a second wood veneer arranged below the first layer 1.

The first layer may be applied in a powder form.

According to an aspect, the building panel is a floor panel or wall panel.

According to an aspect, a building element 10 may comprise a first layer 1 arranged on a substrate 2, the first layer comprising a mixture of a binder, at least one filler and fine non-pigment cohesive particles, wherein said building element is assembled by applying heat and/or pressure to the first layer 1 and/or substrate 2.

A building element according to the above aspects may incorporate all the advantages of the method, which previously has been discussed, whereby the previous discussion is applicable also to the building element.

It is contemplated that there are numerous modifications of the embodiments described herein, which are still within the scope of the invention as defined by the appended claims. For example, it is contemplated that more than one wear resistant foil may be arranged on a core for forming a building panel.

### EXAMPLES

### Example 1

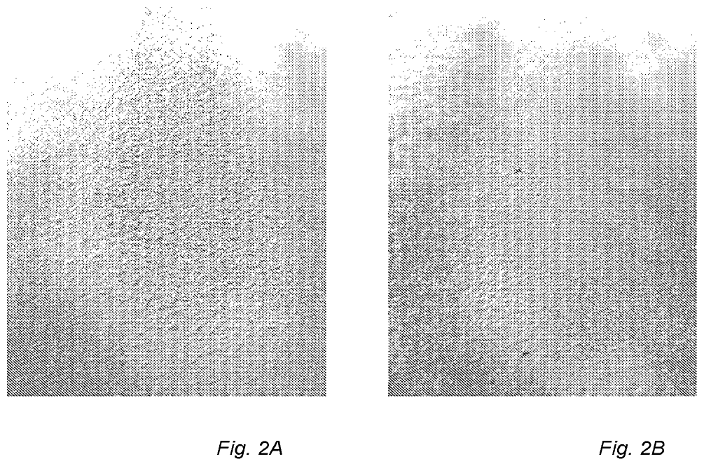

Different powder formulations comprising wood fibres and melamine-formaldehyde resin were made with increasing concentration of ASP® G90, a fine particle aluminium silicate, in order to investigate a connection between the powder free flow and the concentration of ASP® G90 as demonstrated in Table 1. The powder formulations were placed in glass jars to approximately half their volume and visually evaluated as the powders were let flowing by adding an external force to the jars. The typical powder which was considered was flowing without forming aggregates and did not show heavy dust formation which tended to partly adsorb to the jar walls. Acceptable formulation has a more even particle size distribution (FIG. 2B) compared to the reference powder (FIG. 2A).

TABLE 1
Free flow experiment with different concentrations of ASP ® G90

| | ASP G90 | MF | Wood fibres |
|---|---|---|---|
| Formulation | (wt %) | (wt %) | (wt %) |
| A (Ref) | 0 | 54 | 46 |
| B | 1 | 53.5 | 45.5 |
| C | 2 | 53 | 45 |
| D | 3 | 52.5 | 44.5 |
| E | 5 | 51.5 | 42.5 |

Formulation B-E showed significantly higher free flow as visually evaluated than the reference powder A (Ref). There was visually a remarkable improvement between formulation B and C but no notable difference between samples C, D and E.

### Example 2

Different powder formulations comprising wood fibres and a melamine-formaldehyde resin were made with increasing concentration of AEROSIL® 200, a very fine particle fumed silica, in order to investigate a connection between the powder free flow and the concentration of AEROSIL 200®. The mixture compositions are shown in Table 2. The powder formulations were evaluated as described in the Example 1.

TABLE 2
Free flow experiment with different concentrations
of AEROSIL ® 200.

| | AEROSIL ® 200 | MF | Wood fibres |
|---|---|---|---|
| Formulation | (wt %) | (wt %) | (wt %) |
| A (Ref) | 0 | 54 | 46 |
| F | 0.1 | 53.95 | 46.95 |
| G | 3 | 52.5 | 44.5 |

Formulation F and G showed visually remarkable higher free flow than the reference

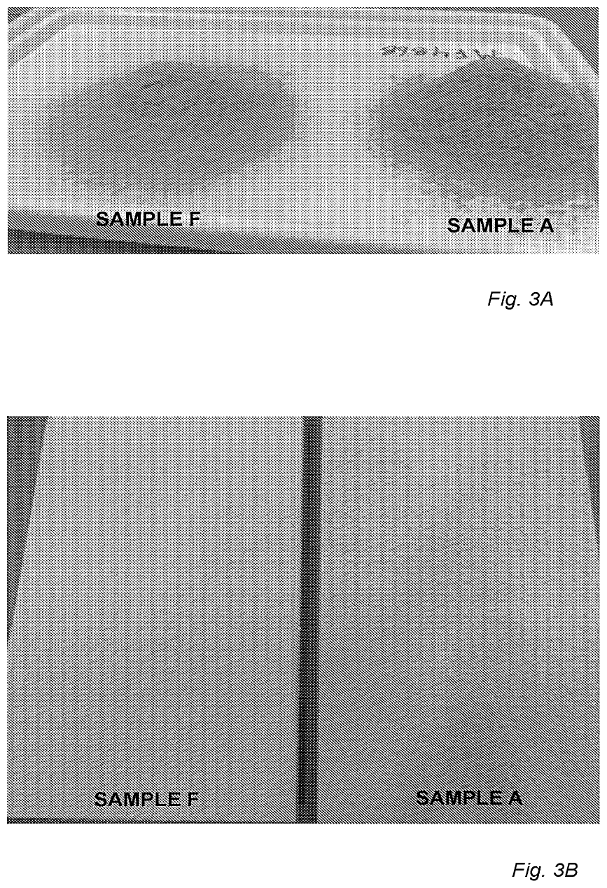

A (Ref), which is further visualized in FIGS. 3A-3B, wherein Sample F is shown as compared to the reference sample A.

When formulations B-E and F-G were used further in the method of manufacturing a building element the formulation was easy to distribute, did not form aggregates. The formulation provided for an even layer thereby improving properties of the first layer and binding of the first layer to the substrate.

### Example 3

From four standardized formulations (A-D in Table 3 below), wherein only the additive part was switched between different inorganic non-pigment fine cohesive particles. These formulations were then run in a permeability program using a Freeman Technology FT4 Powder Rheometer where air is forced through a powder bed at different pressures. Pressure drop is directly negative proportional to permeability. A plot of Pressure drop vs. Applied normal stress was obtained where a high pressure drop is due to a low permeability, meaning higher cohesion in the powder. All powders were then visually inspected and the flowability compared using the glass jar method mentioned in Example 1.

TABLE 3
Standardised formulations.

| Recipe type | A (wt %) | B (wt %) | C (wt %) | D (wt %) | Reference |
|---|---|---|---|---|---|
| Wood fibre | 37.5 | 37.5 | 40 | 41.5 | 42 |
| MF resin | 49 | 52.5 | 52 | 52.5 | 53 |
| Aluminium | 5 | 5 | 5 | 5 | 5 |
| oxide | | | | | |
| Additive | 8.5 | 5 | 3 | 1 | — |

Additives used
MIKHART ® C (CaCO3)
BaSO₄ BB30EX
POLYGLOSS ® 90/ASP ® G90 (aluminium silicate)
Micro talc
Calcinated kaolin
ALGOFLON ® (polytetrafluoreten)
HDK ® N20 (fumed silica)

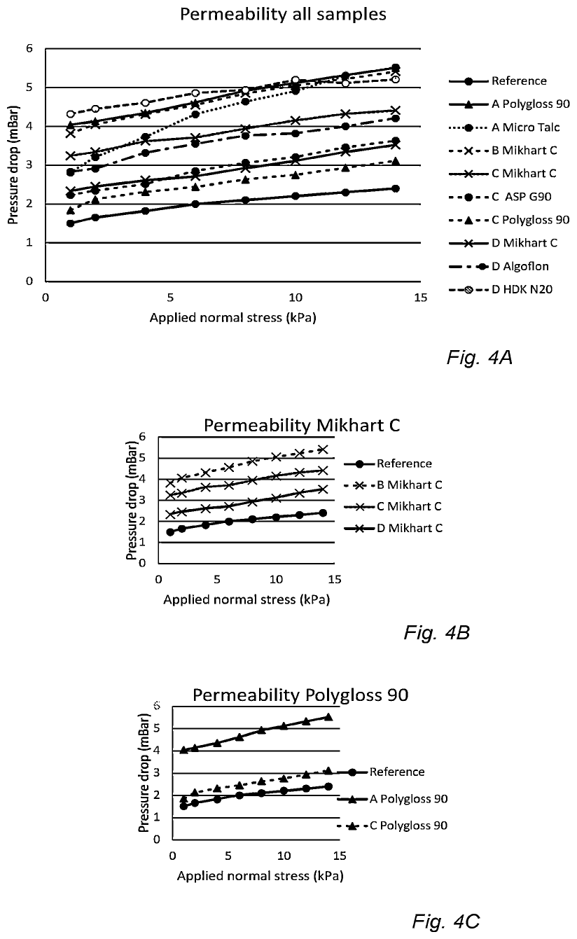

Presented in FIG. 4A is the permeability results, indicating that all samples behaved more cohesively than the reference, as expected. Also, all samples behaved visually more free flowing in the glass jar experiment than the reference. However, seen in FIG. 4B the powder cohesion increased when increasing a certain additive, which was not the case for the free flow. The reference tended to behave with bridge building (mechanical interlocking), which decreased when adding any presented additive up a certain concentration, where the free flow began to decrease again due to the cohesive forces. The optimum free flow agent concentration for the additives presented in this example was 0.5-5 wt %, highly depending on an additive type.

FIG. 4B shows permeability results for MIKHART® C, wherein B, C, D represent the different formulations in Table 3. FIG. 4C shows permeability results for POLYGLOSS® 90 wherein A and C represent the different formulations in Table 3.

When the word “about” or “essentially” is used in this specification in connection with a numerical value, it is intended that the associated numerical value include a tolerance of +/−10% around the stated numerical value.

### EMBODIMENTS

1. A method of manufacturing a building element (10), comprising
applying a first layer (1) on a first surface of a substrate (2), the first layer (1) comprising a mixture of a binder, at least one filler and fine non-pigment cohesive particles, wherein an amount of the fine non-pigment cohesive particles in the mixture is between 0.05 wt % and 9 wt % of the mixture,
applying heat and/or pressure to the first layer (1) and/or the substrate (2) thereby forming the building element (10).

2. The method according to embodiment 1, wherein a cohesion force of said cohesive particles is exceeding a cohesive force of said at least one filler.

3. The method according to embodiment 1 or 2, wherein a cohesion force of said cohesive particles is at least 0.25 kPa, as measured with standard Shear Cell Program, 50 mm shear 6 kPa (FT4 Powder Rheometer).

4. The method according to any one of the preceding embodiments, wherein the mixture is applied in a dry form.

5. The method according to any one of the preceding embodiments, wherein at least 70% of the fine non-pigment cohesive particles have a length in their largest dimension of 2.5 μm or less, preferably a length in their largest dimension between 0.1 μm and 2.5 μm.

6. The method according to any one of the preceding embodiments, wherein the fine non-pigment cohesive particles have a refractive index (RI) of less than 1.9.

7. The method according to any one of the preceding embodiments, wherein the fine non-pigment cohesive particles are selected from silicates, such as aluminium silicate or silicon oxides, such as SiO₂.

8. The method according to embodiment 7, wherein SiO₂ is provided as fumed silica.

9. The method according to any one of embodiments 1-6, wherein the fine non-pigment cohesive particles is selected from calcium carbonate, barium sulphate, polytetrafluorethylene.

10. The method according to any one of the preceding embodiments, wherein said at least one filler comprises wood powder.

11. The method according to any one of the preceding embodiments, wherein the binder is a thermosetting binder.

12. The method according to any one of the preceding embodiments, wherein the first layer (1) further comprises wear resistant particles.

13. The method according to any one of the preceding embodiments, wherein the first layer (1) further comprises pigment particles.

14. The method according to any one of the preceding embodiments, wherein the substrate (2) is a wood-based board, a particleboard, a thermoplastic board, a plywood, a lamella core, a veneer layer.

15. A building element (10), comprising
a first layer (1) arranged on a substrate (2), the first layer (1) formed by a mixture comprising a binder, at least one filler and fine non-pigment cohesive particles,
wherein an amount of the fine non-pigment cohesive particles in the mixture is between 0.05 wt % and 9 wt % of the mixture,
wherein said building element (10) is formed by applying heat and/or pressure.

16. The building element according to embodiment 15, wherein a cohesion force of said cohesive particles is exceeding a cohesive force of said at least filler.

17. The building element according to embodiment 15 or 16, wherein a cohesion force of said cohesive particles is at least 0.25 kPa, as measured with standard Shear Cell Program, 50 mm shear 6 kPa (FT4 Powder Rheometer).

18. The building element according to any one of embodiments 15-17, wherein the mixture is applied in a dry form.

19. The building element according to any one of embodiments 15-18, wherein at least 70% of the fine non-pigment cohesive particle has a length in its largest dimension of 2.5 μm or less, preferably a length in its largest dimension between 0.1 μm and 2.5 μm.

20. The building element according to any one of embodiments 15-19, wherein the fine non-pigment cohesive particles have a refractive index (RI) of less than 1.9.

21. The building element according to any one of embodiments 15-20, wherein the fine non-pigment cohesive particles are selected from silicates, such as aluminium silicate or silicon oxides, such as SiO₂.

22 The building element according to embodiment 21, wherein SiO₂ is provided as fumed silica.

23. The building element according to any one of embodiments 15-20, wherein the fine non-pigment cohesive particles is selected from calcium carbonate, barium sulphate, polytetrafluorethylene.

24 The building element according to any one of embodiments 15-23, wherein said at least one filler comprises wood powder.

25. The building element according to any one of embodiments 15-24, wherein the binder is a thermosetting binder.

26. The building element according to any one of embodiments 15-25, wherein the first layer (1) further comprises wear resistant particles.

27. The building element according to any one of embodiments 15-26, wherein the first layer (1) further comprises pigment particles.

28. The building element according to any one of embodiments 15-27 wherein the substrate (2) is a wood-based board, a particleboard, a thermoplastic board, a plywood, a lamella core, a veneer layer.

1-28. (canceled)

29. A method of manufacturing a building panel, comprising:
applying a first layer on a first surface of a substrate; and
applying heat and/or pressure to the first layer and/or the substrate thereby forming the building panel,
wherein the first layer comprises a mixture of:
a binder;
at least one filler comprising fibers; and
a mix of fine non-pigment cohesive particles, the mix containing at least 70% of fine non-pigment cohesive particles with a length in their largest dimension of at least 0.1 μm,
wherein an amount of the fine non-pigment cohesive particles in the mixture is between 0.05 wt % and 9 wt % of the mixture, and
wherein the fine non-pigment cohesive particles are configured to contribute to a flowability of the mixture of the first layer when the first layer is applied on the first surface of the substrate.

30. The method according to claim 1, wherein a cohesion force of the fine non-pigment cohesive particles exceeds a cohesive force of the at least one filler.

31. The method according to claim 1, wherein a cohesion force of the fine non-pigment cohesive particles is at least 0.25 kPa, as measured with standard Shear Cell Program, 50 mm shear 6 kPa.

32. The method according to claim 1, wherein at least 70% of the fine non-pigment cohesive particles have a length in their largest dimension of 2.5 μm or less.

33. The method according to claim 1, wherein the fine non-pigment cohesive particles have a refractive index of less than 1.9.

34. The method according to claim 1, wherein the fine non-pigment cohesive particles are selected from silicates or silicon oxides.

35. The method according to claim 34, wherein SiO₂ is provided as fumed silica.

36. The method according to claim 1, wherein the fine non-pigment cohesive particles is selected from calcium carbonate, barium sulphate, polytetrafluorethylene.

37. The method according to claim 1, wherein the fine non-pigment cohesive particles are in the mixture in an amount of between 0.5 wt % and 5 wt % of the mixture.

38. The method according to claim 1, wherein the fine non-pigment cohesive particles are in the mixture in an amount of between 1 wt % and 7 wt % of the mixture.

39. The method according to claim 1, wherein the fine non-pigment cohesive particles are in the mixture in an amount of between 2 wt % and 6 wt % of the mixture.

40. The method according to claim 1, wherein the fine non-pigment cohesive particles coat the at least one filler.

41. The method according to claim 1, wherein the fibers have an average particle size of 10-300 μm.

42. The method according to claim 1, wherein the at least one filler comprises wood fibers.

43. The method according to claim 1, wherein the at least one filler comprises wood powder.

44. The method according to claim 1, wherein the mixture is applied in a dry form.

45. The method according to claim 1, wherein the binder is a thermosetting binder.

46. The method according to claim 1, wherein the first layer further comprises wear resistant particles.

47. The method according to claim 1, wherein the first layer further comprises pigment particles.

48. The method according to claim 1, wherein the substrate is a wood-based board, a particleboard, a thermoplastic board, a plywood, a lamella core, a veneer layer.
